(19) United States
(12) Patent Application Publication
(10) Pub. No.: US 2005/0289204 A1
(43) Pub. Date: Dec. 29, 2005

(54) Parallel feedback processing

(76) Inventors: Jose Tellado, Sunnyvale, CA (US); Glenn David Golden, Boulder, CO (US); Sanjay Kasturia, Palo Alto, CA (US); Jeffrey V. Hill, San Jose, CA (US); John Dring, San Jose, CA (US)

Correspondence Address: Brian R. Short;Teranetics Patent Department, P.O. Box 641867, San Jose, CA, 95164-1867, US

(21) Appl. No.: 10/880,052

(22) Filed: Jun. 29, 2004

(51) Int. Cl. G06F 7/00

(52) U.S. Cl. 708/300

(57) ABSTRACT

Embodiments of a parallel feedback processor are disclosed. The parallel feedback processor includes a plurality of parallel coupled feedback filters. Each feedback filter includes a non-linear operator. At least one of feedback filter includes a plurality of sub-filters. Each sub-filter computes a one of possible non-linear operator filter outputs of the at least one feedback filter. One sub-filter output is selected as an output of the at least one feedback filter.

### FIELD OF THE INVENTION

The invention relates generally to digital communications. More particularly, the invention relates to a method and apparatus for parallel feedback processing.

### BACKGROUND OF THE INVENTION

High-speed networks are continually evolving. The evolution includes a continuing advancement in the operational speed of the networks. The network implementation of choice that has emerged is Ethernet networks physically connected over unshielded twisted pair wiring. Ethernet in its 10BASE-T form is one of the most prevalent high speed LANs (local area network) for providing connectivity between personal computers, workstations and servers.

High-speed LAN technologies include 100BASE-T (Fast Ethernet) and 1000BASE-T (Gigabit Ethernet). Fast Ethernet technology has provided a smooth evolution from 10 Megabits per second (Mbps) performance of 10BASE-T to the 100 Mbps performance of 100BASE-T. Gigabit Ethernet provides 1 Gigabit per second (Gbps) bandwidth with essentially the simplicity of Ethernet. There is a desire to increase operating performance of Ethernet to even greater data rates.

An implementation of high speed Ethernet networks includes simultaneous, full bandwidth transmission, in both directions (termed full duplex), within a selected frequency band. When configured to transmit in full duplex mode, Ethernet line cards are generally required to have transmitter and receiver sections of an Ethernet transceiver connected to each other in a parallel configuration to allow both the transmitter and receiver sections to be connected to the same twisted wiring pair for each of four pairs.

FIG. 1 shows several Ethernet twisted pair LAN connections 112, 114, 116, 118 in parallel. The first connection 112 is between a first transmitter 115a (S1A) and first receiver 125a (R1A), and a second transmitter 115b (S1B) and a second receiver 125b (R1B). The second connection 114 is between a third transmitter 135a (S2A) and third receiver 145a (R2A), and a fourth transmitter 135b (S2B) and a fourth receiver 145b (R2B). The third connection 116 is between a fifth transmitter 155a (S3A) and fifth receiver 165a (R3A), and a sixth transmitter 155b (S3B) and a sixth receiver 165b (R3B). The fourth connection 118 is between a seventh transmitter 175a (S4A) and seventh receiver 185a (R4A), and an eighth transmitter 175b (S4B) and an eighth receiver 185b (R4B).

The twisted pair LAN connections 112, 114, 116, 118 are located physically proximate, and interference between the twisted pairs 112, 114, 116, 118 is caused by interactions between signals of the twisted pair LAN connections 112, 114, 116, 118. The interference is in the form of far end cross-talk (FEXT) and near-end cross-talk (NEXT). NEXT is caused by interference due to signals generated at the near-end of a neighboring twisted pair connection. For example, NEXT interference includes the transmitter signals S1A, S3A, S4A of transmitters 115a, 155a, 175a interfering with receiver signal R2A of receiver 145a. FEXT is caused by interference due to signals generated at the far-end of a neighboring twisted pair connection. For example, FEXT interference includes the transmitter signals S1B, S3B, S4B of transmitters 115b, 155b, 175b interfering with receiver signal R2A of receiver 145a. Other interference includes the echo signal. For example, the echo signal includes interference the signal S2A of transmitter 135a interfering with the receiver signal R2A of receiver 145a. Additional interference includes inter-symbol interference (ISI). ISI is self-interference of the transmit signal S2B at the input R2A of the receiver 145a. Other interference can include alien signal interference. Alien signal interference generally includes interference due to other Ethernet twisted pair LAN connections of cables that may be proximate to the twisted pair cable of the signal of interest.

A possible solution to addressing ISI is to include a decision feedback equalizer (DFE) in the Ethernet receiver, to cancel interference of adjacent (past and future) signals. However, a DFE can suffer from error propagation problems because once an error has been introduced into a decision sample, the DFE will propagate the error through the feedback filter over many subsequent samples.

Alternatively, a feedback equalizer can be included within the transmitter, thereby eliminating the need for a DFE in the receiver. Simple implementations of transmitter feedback equalizers can generate output signals having amplitudes that are substantially greater than the amplitudes of the un-equalized signal streams. This can be undesirable because transmission signals having large signal amplitudes require higher power transmitter output chains. Additionally, high power transmission signals are more likely to suffer from distortion, and generate more electromagnetic interference that can be received by other devices

If the channel impulse response of the Ethernet channel is known, a Tomlinson-Harashima precoder can be used in the Ethernet transmitter, eliminating the need for a DFE in the Ethernet receiver. The precoder compensates for interference in a channel having an equivalent time response. A Tomlinson-Harashima precoder, however, produces transmission signals having amplitudes that are comparable with the amplitudes of the un-equalized signals.

FIG. 2 shows an embodiment of an intranspose FIR form of a Tomlinson-Harashima precoder. The precoder includes a modulo unit 210. The modulo unit 210 maps amplitudes of input signals down to a range that is comparable to the range of amplitudes of the signals received by the precoder, thereby maintaining low amplitude, low power signals at the output of the precoder.

The precoder additionally includes a feedback structure including an FIR filter. The feedback structure includes a series of delays 220, 222, 224, 226, 228, a series of multipliers 230, 232, 234, 236, 238 and summers 240, 242, 244, 246, 248. The precoder generates a digital signal stream Yₙ that is preprocessed to minimize the effects of ISI (and in some cases FEXT) during transmission of the digital signal stream Yₙ. The receiver of the digital signal stream includes an equivalent modulo unit as the modulo unit 210 of the transmitter, that reverses the modulo operation of the transmitter.

The operational speed of this Tomlinson-Harashima precoder is limited by the time required for the operations of the first feed back branch of the feedback filter. More specifically, the critical path of the filter is the first multiplier 238 plus the adder 248 and the modulo 210. Generally, the operational speed is limited by the speed in which the first multiply and add can be executed. These operations must be completed with a single time delay (Z⁻¹), which determines the maximum operational speed of the precoder.

It is desirable to have a high throughput (high speed) transceiver that provides preprocessing for minimization of interference (ISI, FEXT) of Ethernet LAN signals. The processing should require a minimal amount of electronic hardware, and dissipate a minimal amount of power, while operating at high speeds, and generating processed signals having reasonable signal amplitudes.

### SUMMARY OF THE INVENTION

An embodiment of the invention includes a parallel feedback processor. The parallel feedback processor includes a plurality of parallel coupled feedback filters. Each feedback filter includes a non-linear operator. At least one of the feedback filters includes a plurality of sub-filters. Each sub-filter computes a one of possible non-linear operator filter outputs. One sub-filter output is selected as an output of the at least one feedback filter.

Another embodiment of the invention includes a method of parallel feedback processing. The processing includes receiving a digital stream of samples. A first feedback filter chain receives a subset of the samples. A second feedback filter chain simultaneously receives a different subset of the samples. The second feedback filter includes a plurality of sub-filters, in which the sub-filters receive a different subset of samples, and each sub-filter processes a different one of multiple possible modulo shifts. The first feedback filter selects one of the sub-filter processed outputs as an output of the second feedback filter chain.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 shows a plurality of transceiver pairs located adjacently, and suffering from cross-talk interference between signal streams of the transceiver pairs.

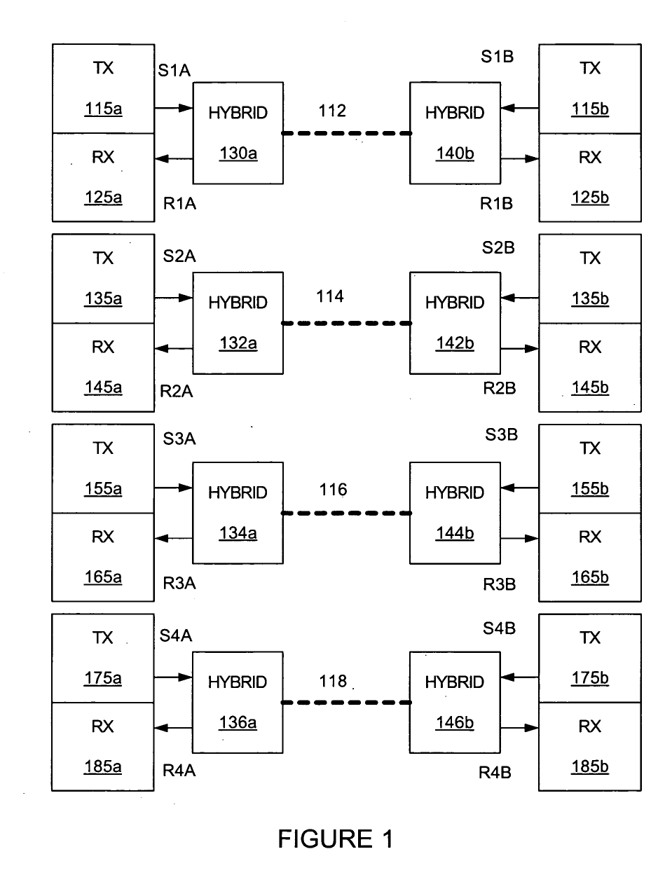

FIG. 2 shows a Tomlinson-Harashima precoder.

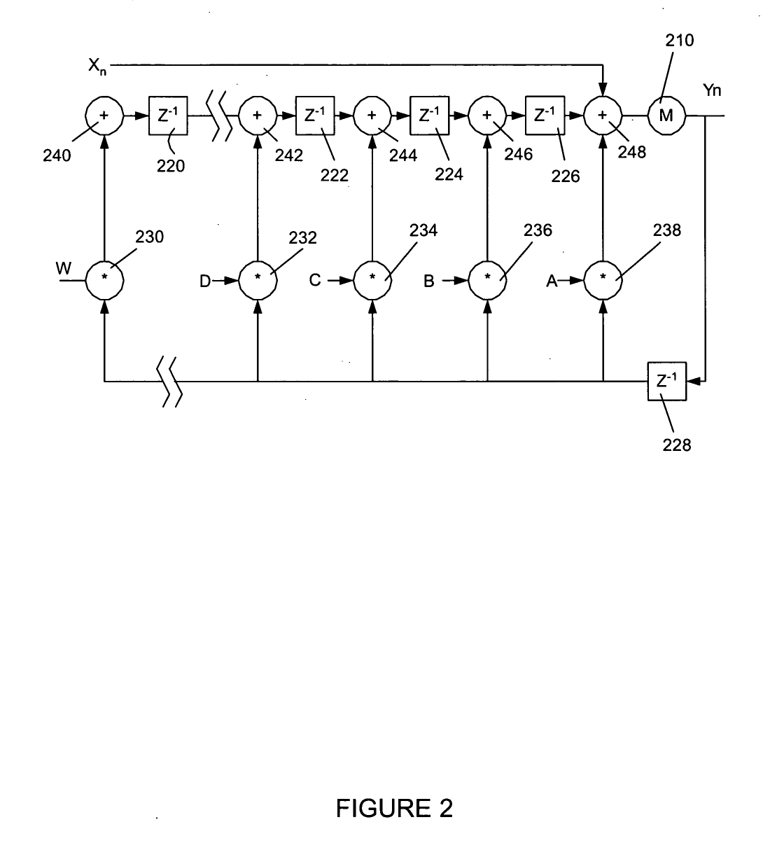

FIG. 3 shows high-speed parallel feedback processor.

FIG. 4 shows a range of amplitudes of digital samples at an input, and at an output of a modulo unit.

FIG. 5 shows another high-speed parallel feedback processor.

FIG. 6 shows a range of amplitudes of digital samples at an input, and at an output of a modulo unit, for the parallel feedback processor of FIG. 5.

FIG. 7 is a flow chart showing steps included in a method of parallel feedback processing.

FIG. 8 is a block diagram of a server/computer, a switch and storage that can benefit from the use of a parallel feedback processor.

### DETAILED DESCRIPTION

As shown in the drawings for purposes of illustration, the invention is embodied in an apparatus and method for high-speed parallel feedback processing that reduces the effects of transmission interference. The transmission interference can include FEXT and ISI Ethernet transmission interference.

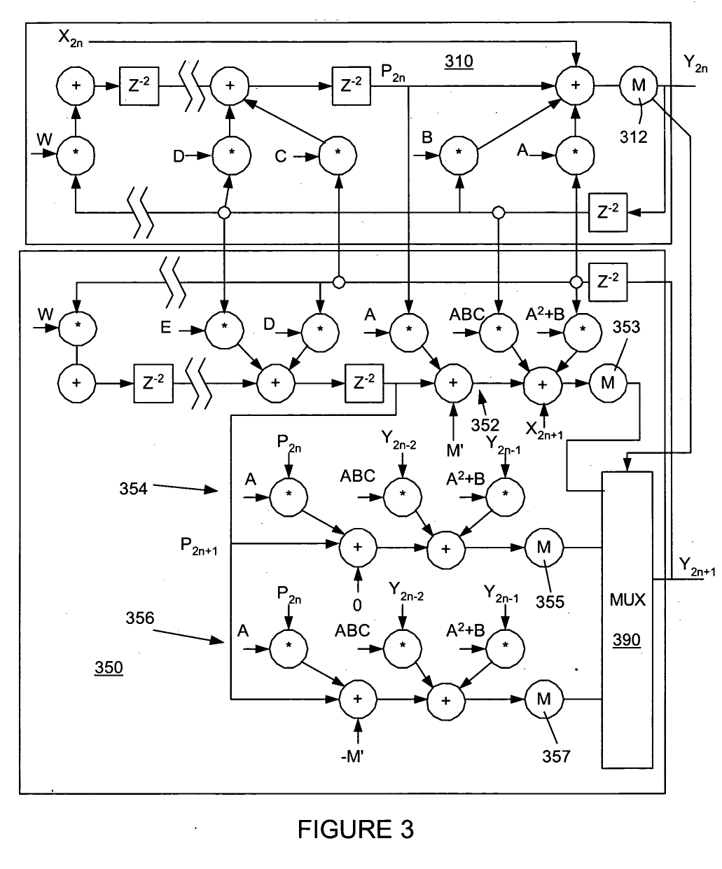

FIG. 3 shows an Ethernet parallel feedback processor. The parallel feedback processor includes two primary FIR (finite impulse response) feedback filters 310, 350. The first feedback filter 310 and the second feedback filter 350 each receive a subset of the samples of a transmit stream. Specifically, the first feedback filter 310 receives the X₂ₙ samples, and the second feedback filter 350 receives the X₂ₙ₊₁ samples. As shown in FIG. 3, the first feedback filter 310 receives the even samples, and the second filter 350 receives the odd samples, or vice versa. The two parallel feedback filters 310, 350 of FIG. 3 can easily be expanded to include any number of parallel, coupled feedback filters. As will be described, one embodiment includes the number of sub-filters being equal to the number of possible modulo shifts of a modulo operator. Generally, the number of possible modulo shifts is determined by the (feedback) coefficients of the feedback filters. As shown in FIG. 3, the feedback filters 310, 350 include finite impulse response (FIR) filters. Other embodiments can include infinite impulse response (IIR) filters.

Delay units Z⁻² each provide a delay having a time duration of two samples. Two sample delays are used because every other sample is generated by a different one of the two feedback filters 310, 350. A parallel feedback processor that includes a different number of coupled feedback filters would include delay units having correspondingly different time delay durations.

The first feedback filter 310 generates the Y₂ₙ preprocessed samples, and the second feedback filter 350 including a set of sub-filters 352, 354, 356 generates the Y₂ₙ₊₁ preprocessed samples. The first feedback filter 310 includes a modulo unit 312. The sub-filters 352, 354, 356 include modulo units 353, 355, 357, and simultaneously compute a multiplicity of output samples that are dependent upon the other feedback filters. A single output sample generated by the sub-filters 352, 354, 356 is selected by the modulo unit 312 of the feedback filter 310. The modulo units 312, 353, 355, 357 can alternatively be implemented with comparable non-linear operators. For example, another non-linear operator includes a multilevel constellation (such as QAM, PAM, etc) slicer unit in a receiver implementation of a DFE, and a dynamic limited precoder. Most of the descriptions here pertain to modulo units and modulo shifts. However, these descriptions can also be extended to multilevel slicers and slicer output values. For example, the slicer for a PAM8 receiver typically has eight possible output levels. The finite number of levels can be used as inputs to sub-filters.

Generalized Modulo Desription

Given a real valued number X, and a modulo shift value M′, the real value output number Y (called remainder) and the integer K (called quotient) can be defined as:
Y=MOD[X]=X−KM′

Typically K is chosen such that the absolute value of Y is less than (or equal to) M′/2, that is |Y|<=M′/2, which minimizes the amplitude of Y. This is the definition of MOD typically used for THP. Other criteria for K can be used, such that it minimizes the average power of a sequence of values of Y over time (such as trellis shaping), or that minimize the complexity of the overall feedback filter. For these cases |Y| will not always be less than M′/2, but will have other benefits. The term modulo is often used in this context. For example, embodiments will be described in which the modulo is computed with reduced precision of the coefficients or input sample values to speed up or reduce the amount of hardware.

The multiple sub-filters 352, 354, 356 generate multiple modulo condition outputs. Each sub-filter generates its output based upon previous samples. The desired output is selected by the first feedback filter 310, and as shown in FIG. 3, by the modulo unit 312. By generating many if not all possible modulo condition outputs, determination of a best second feedback filter output can be made by selecting one of the sub-filter 352, 354, 356 outputs. By calculating the modulo outputs simultaneously, the parallel processing can completed more quickly, while using filter components (for example, multipliers and adders) that are slower. The accuracy of the estimated output is dependent upon the number of sub-filters. A less accurate, but possibly acceptable estimated output, can be made by fewer sub-filters.

As shown in FIG. 3, the sub-filters 352, 354, 356 are essentially identical, but the first sub-filter 352 receives a modulo shift of M′, the second sub-filter receives a modulo shift of 0, and the third sub-filter receives a modulo shift of −M′. Other coefficients of the sub-filters 352, 354, 356 (A, ABC, A²+B) are predetermined. The sub-filters 352, 354, 356 also receive partial values of prior (previous) filter coefficients. More specifically, the sub-filters 352, 354, 356 also receive P₂ₙ and P₂ₙ₊₁. The outputs of the modulo units 353, 355, 357 are connected to a MUX 390, which allow one of the outputs to be selected as the second feedback filter 350 output. This allows three possible modulo shifts to be calculated in parallel, thereby allowing the desired one of the possible modulo shifts to be effectively calculated more quickly. Clearly, more sub-filters having additional and/or different modulo shifts can be included.

Partial filter sections of the first feedback filter 310 and the second feedback filter 350 include multipliers that receive coefficients designated as {C, D, E, . . . , W}. This is a simplification, and can include any number of additional multipliers and taps.

An FIR representation of the THP is:
Y₂ₙ₊₁=MOD[AY₂ₙ+BY₂ₙ₋₁+CY₂ₙ₋₂+DY₂ₙ₋₃+ . . . +WY_{2n-nw}+X₂ₙ₊₁]

Designating P₂ₙ₊₁ as the partial value associated with previous feedback values, where P₂ₙ₊₁=DY₂ₙ₋₃+ . . . +WY_{2n-nw}, the equation above can be rewritten as:
Y₂ₙ₊₁=MOD[AY₂ₙ+BY₂ₙ₋₁+CY₂ₙ₋₂+P₂ₙ₊₁+X₂ₙ₊₁]

Computation of two parallel samples requires each feedback filter computing the latest value based on the latest input and previous output values, starting at two samples earlier. That is, Y₂ₙ₊₁ must be computed based on the input sequence X₂ₙ₊₁, and prior feedback values Y₂ₙ₋₁, Y₂ₙ₋₂, etc., but without using Y₂ₙ. This is typically referred to as “loop unrolling.”

The calculation of the Y₂ₙ₊₁ output, can be determined. More specifically,
Y₂ₙ₊₁=MOD[AY₂ₙ+BY₂ₙ₋₁+CY₂ₙ₋₂+P₂ₙ₊₁]

After substituting Y₂ₙ above we get the new equation which does not include the term Y₂ₙ;
Y₂ₙ₊₁=(A²+B)Y₂ₙ₋₁+ABCY₂ₙ₋₂+AP₂ₙ−K₂ₙM′+P₂ₙ₊₁

Although the equation can compute Y₂ₙ₊₁ without the value for Y₂ₙ, it does depend on the modulo shift value K₂ₙ associated with the output Y₂ₙ. As shown in FIG. 3, there are three possible values of Y₂ₙ₊₁ calculated using three different values of K₂ₙ of (−1, 0, +1). The Y₂ₙ sample value (modulo quotient) is used to select the correct Y₂ₙ₊₁.

The modulo units generate a remainder and a quotient. The remainder is the output, and the quotient of the modulo unit 312 can be used to control the selection of the sub-filters of the second filter.

Number of Possible Modulo Shifts

The input streams of data bits can be used to pulse amplitude modulate (PAM) signals. Amplitudes of the PAM samples are generally represented by a set of zero mean integers. For example, a transmit stream of (binary) data bits can be grouped into groups of 3 bits and mapped into a stream of samples with eight amplitude levels. Typically, a PAM signal with 8 levels is digitally represented by an input stream with values from the list {−7, −5, −3, −1, +1, +3, +5, +7}. An example of a valid PAM8 stream includes Xₙ=[−5, +7, +1, −3, −3, +7, etc . . . ].

When the input samples are passed through a feedback filter, the amplitudes of the samples within the feedback filter (prior to the modulo unit) vary depending upon the number of taps of the feedback filter, and the values of the coefficients of the feedback filter. For example, the range of amplitudes of the samples within the feedback filter (prior to the modulo unit) could range from −23 to +23 (this range is merely selected as an example, the range can be much larger or smaller). For example, if the feedback filter has one coefficient represented by the equation Yₙ=Yₙ₋₁+Xₙ, and the input sequence is Xₙ=[+7, +5, +5, −1, +7 . . . ], the samples within the feedback filter are Yₙ=[+7, +12, +17, +16, +23, . . . ]. As previously stated, the modulo unit maps the amplitudes of the samples to a range that is approximately the same as the range of the input samples (−8, +8). For the suggested example, the modulo unit maps the amplitudes of the samples from the range of (−23, +23) to a range approximately the same the range of input sample. The mapped range could be, for example, (−8, +8). Typically for PAM with M levels, the modulo shift is chosen to be M′=2M and thus the typical modulo output interval is (−M, M), which for PAM8 would be (−8, 8).

The mapped range of (−8, +8) spans 16 units of the real axis. The range of 16 can be used to determine the number amplitude modulo shifts that are required to shift an input sample amplitude to be within the mapped range. For example, if an input sample has an amplitude of 15, a single negative shift of 16 shifts the amplitude of the input sample to an amplitude of −1, which is within the modulo output mapped range. The number of shifts required to shift the amplitudes of all the amplitudes of the filtered output samples to within modulo output mapped range determines the ideal number of required sub-filters, and can be termed the “number of possible modulo shifts.” Factors that influence the size of the number of possible modulo shifts include the modulo operator used, the range of amplitudes of the PAM samples, the range of amplitudes of the filtered samples (which is dependent upon the range of values of the coefficients of the feedback filter) and the range of amplitudes of the mapped range.

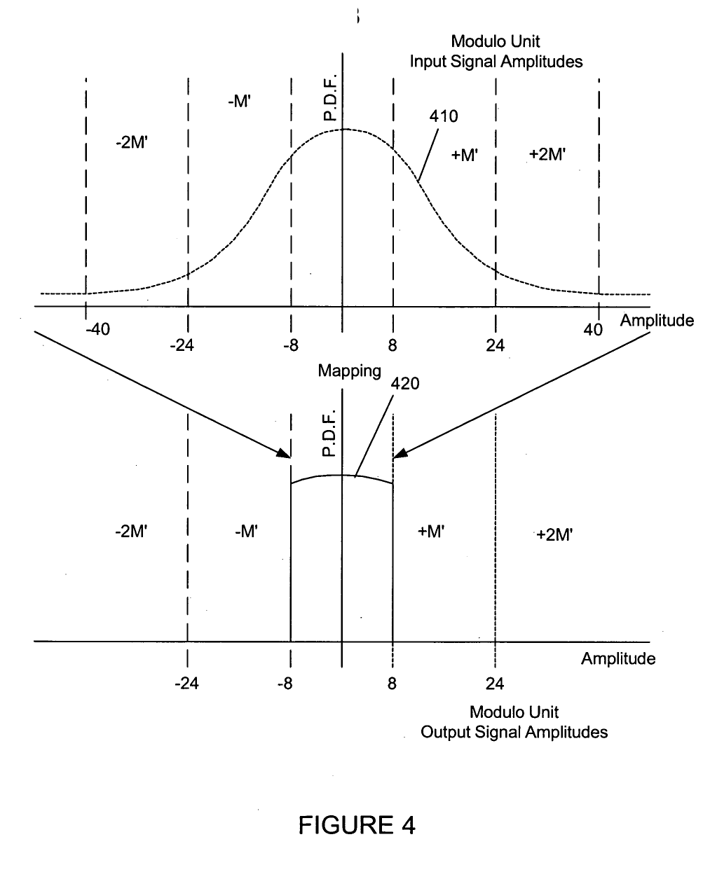

FIG. 4 shows possible input and output signal values of the modulo unit. The range of input values is mapped into the range of output values. The Tomlinson-Harashima precoder includes a modulo device with a feedback loop. The modulo device takes each input signal and maps the amplitude of the signal so that the amplitude after mapping falls within the range of amplitudes of the PAM samples. The vertical axis is a probability density function (PDF) of the signal amplitudes.

Curve 410 of FIG. 4 shows a possible range of modulo unit input signal amplitudes. Generally, the input values are concentrated within the range of pre-filtered values. Here, this is the range of (−7, +7). However, the feedback filter can cause the filtered amplitude values to be much larger, depending upon the values of the filtering coefficients, and the number of filter taps. As previously described, it is desirable to limit the range of the amplitudes.

Curve 420 of FIG. 4 shows a possible range of modulo unit output signal amplitudes. As shown, the amplitudes are mapped to a range of (−8, +8). The modulo units of FIG. 3 perform a similar type of amplitude mapping. The modulo mapping is dependent upon the magnitude of the amplitude of the input signal. The input amplitudes are all mapped down to the −8 to +8 amplitude range.

Sub-Filters Selection

The sub-filters of the processor (for example, the processor shown in FIG. 3) can be selected in various different ways. A first method includes selecting the number of sub-filters to be the same as the previously described number of possible modulo shifts. If the number of possible modulo shifts is five, then five sub-filters are selected. If the feedback of the THP is implemented with an FIR filter, then the largest input signal to the modulo unit occurs when the current output of the modulo unit has the maximum amplitude (+8 or −8 for the examples above) and the sign of the sequence of preceding modulo output matches the signs of the feedback FIR coefficients. For example, if the THP feedback filter FIR coefficients are [1, 0.5, −0.75] (that is, the THP modulo unit performs the operation Yₙ=MOD[Yₙ₋₁+0.5Yₙ₋₂−0.75Yₙ₋₃+Xₙ]) then the maximum amplitude into the modulo unit occurs when the previous values are Yₙ₋₁=+8, Yₙ₋₂=+8, Yₙ₋₁=−8, Xₙ=+7, which results in +8+0.5*8+(−0.75)*(−8)+7=25. In general, the sum of the absolute values of the feedback FIR coefficients will yield the largest number of possible modulo shifts. In this case, the modulo input signal is in the interval (−25, 25) and the output in the interval (−8, +8). The number of possible modulo shifts is 5, which covers the modulo shift values −2*16, −16, 0, 16, 2*16. The first modulo shift covers the input values (−40, −24), the second is (−24, −8), and the fifth is (24, 40). Note that overlapping values can go to either shift. For example, −24 can be within either the (−40, −24) interval, or the (−24, −8) interval. Since the input values to the feedback filter are typically iid (independently and identically, distributed) uniform with zero mean and the output is also iid uniform with zero mean, the THP feedback filter generates samples that are typically closer to zero than to the max values described above for the number of possible modulo shifts. In the case above, the input to the modulo unit is only 25 for the worst case sequence described, which is rather unlikely. Moreover, the first and last modulo shift intervals (−40, −24) and (24, 40), only have a small region of interest, specifically, the interval (24, 25), since inputs greater than 25 or less than −25 are not feasible.

The parallel feedback processor of FIG. 3 only showed one of the feedback filters having sub-filters. However, more than one of the feedback filters can include sub-filters. One embodiment includes a plurality of feedback filters having sub-filters. For example, for the case with 3 parallel filters, the second parallel filter will typically have a number of sub-filters related to the number of possible modulo shifts of the first parallel feedback filter. The third parallel feedback filter will typically depend on the modulo quotient of the first and second parallel feedback filters, and thus the number of sub-filters will be related to the product of the number of possible modulo shifts of each of the two first parallel filters. In general the Lth parallel feedback filter will comprise a number of sub-filters related to the product of the previous (L−1) number of possible modulo shifts.

Other embodiments can include selectively reducing the number of sub-filters. For example, the number of sub-filters can be based upon a statistical analysis of which of the modulo shifts are most likely to be used. The modulo shifts that are used the least can be eliminated. This results is less effective transmit signal preprocessing, but reduces the amount of hardware circuitry required to implement the transmit signal preprocessing. For example, a number of possible modulo shifts may be determined to be five, suggesting that the preprocessing should include five sub-filters. However, three sub-filters may be satisfactory if the reduction to three sub-filters does not substantially effect the transmit signal preprocessing. In the example provided above, the modulo shifts of −2*16 and 2*16 are used very infrequently and can be removed from the signal processor to reduce the amount of electronic circuitry hardware.

Another embodiment includes reducing the number of sub-filters, and dynamically controlling the modulo shifts based upon partial values of prior (previous) filter coefficients. Due to the memory in the feedback filter, typically the input samples to the modulo unit are correlated and the required modulo shifts do not vary drastically from sample to sample. Therefore, the subset of modulo shifts computed in the sub-filters can be dynamically selected so that the available modulo shifts are within a range as determined by the modulo shift of prior samples.

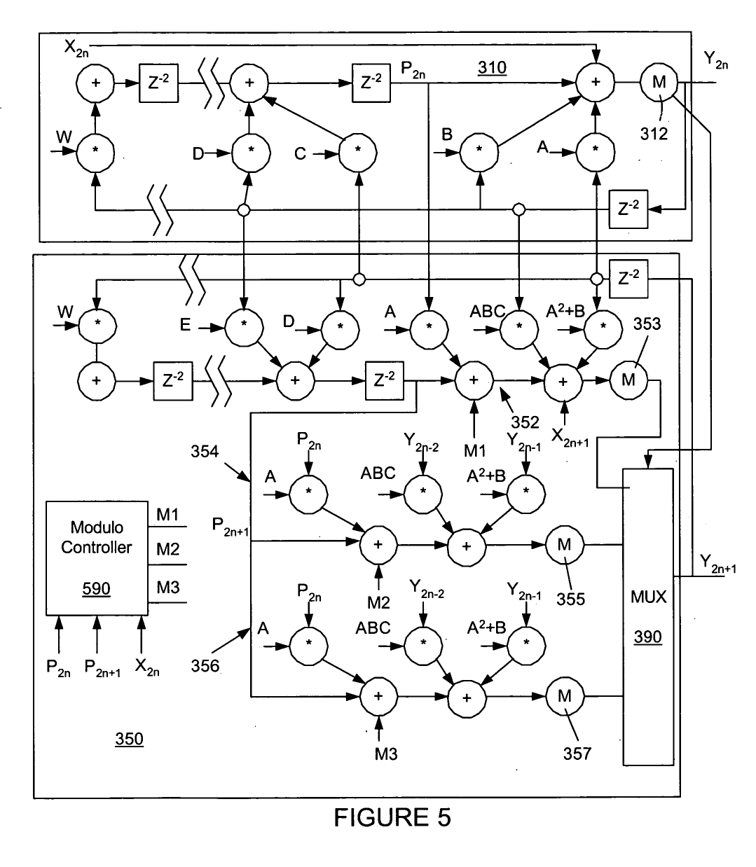

FIG. 5 shows another high-speed parallel processor. This processor includes a modulo controller 590 that dynamically selects a subset of modulo shifts based upon prior information of the feedback filter, such as partial values of prior (previous) filter coefficients. That is, rather than having the modulo shifts being a set of predetermined values, the modulo shifts are dynamically determined based upon partial values of previously filtered samples. In FIG. 5, the modulo shifts of M′, 0 and −M′ of FIG. 3, have been replaced by dynamically controlled modulo shifts M1, M2, M3. The modulo shifts M1, M2, M3 are dynamically determined by the modulo controller 590 based upon the partial values of prior coefficients P₂ₙ and P₂ₙ₊₁, and in some cases X₂ₙ₊₁ and X₂ₙ. For example, if the number of possible modulo shifts is five, and as shown in FIG. 5, there are only three sub-filters available, the modulo shifts M1, M2, M3 typically include three successive modulo shift values centered around the value given by the partial values P₂ₙ and P₂ₙ₊₁. Recalling the previous example with feedback FIR coefficients [1, 0.5, −0.75], the outputs Y₂ₙ and Y₂ₙ₊₁ of two parallel feedback filters can be any real number in the range (−25, 25). However, this range can be significantly reduced by using prior information or partial values in the filter computation. For example, if the previous sample values are Y₂ₙ₋₁=+8, Y₂ₙ₋₂=+8, Y₂ₙ₋₁=−8, and the FIR coefficients are [1, 0.5, −0.75], the output is:

$${Y}_{2 n + 1} = MOD [ {Y}_{2 n} + 0.5 {Y}_{2 n - 1} - 0.75 {Y}_{2 n - 2} + {X}_{2 n + 1} ] = \\ = MOD [ {Y}_{2 n} + 4 + 6 + {X}_{2 n + 1} ]$$

Using the partial information, the input to the modulo unit is limited to the range (−8, 8)+10+(−7, 7)=(−5, 25). Therefore, the sub-filters that compute the modulo shift −2*16 and −1*16 are not required. In this derivation, knowledge of the partial values of filter coefficients 0.5 and −0.75 is applied to the previous outputs Y₂ₙ₋₁ and Y₂ₙ₋₂.

For example, in FIG. 5, the values P₂ₙ and P₂ₙ₊₁ are partial values that include the effects of prior values of Y₂ₙ₋₃, Y₂ₙ₋₄, etc, and the prior coefficients C, D, E, . . . , W. Since the input to the modulo unit for the parallel feedback filters is influenced by the values of P₂ₙ and P₂ₙ₊₁, these values can be influential in selecting the modulo shifts for the reduced set of sub-filters.

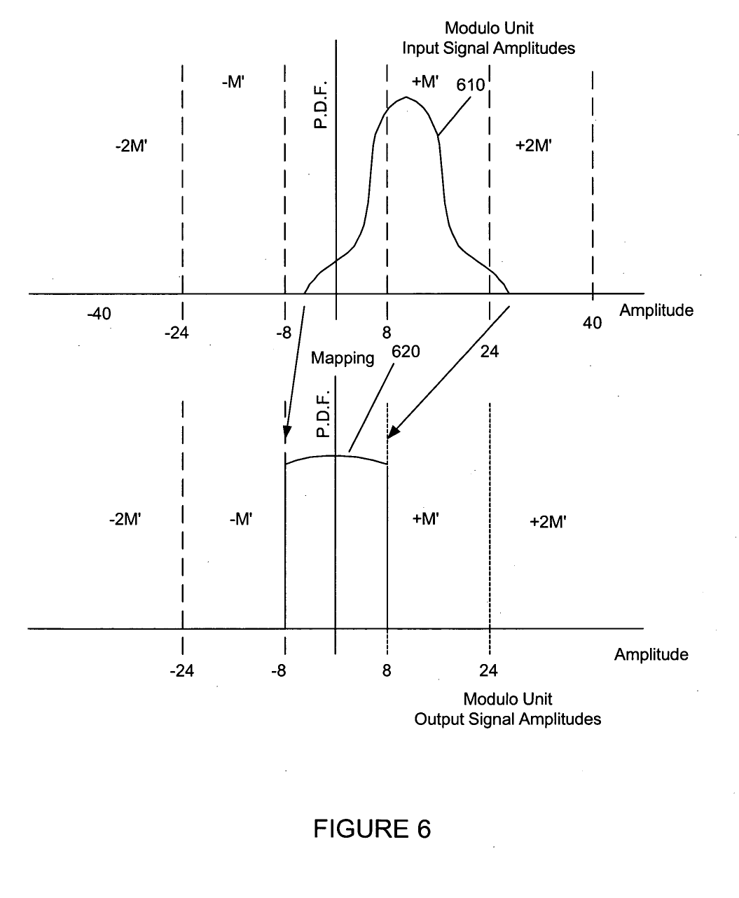

FIG. 6 shows a range of amplitudes of digital samples at an input, and at an output of a modulo unit, for the parallel feedback processor of FIG. 5. The curve 610 shows the amplitudes of the signals input to the modulo unit 312. As compared to the curve 410 of FIG. 4, the range of the input values are skewed to a value of approximately 10, and the range of modulo shifts required is reduced. The feedback partial value is approximately 10, and the range of input values is about −5 to 25. The number of possible modulo shifts is less, and the number of required sub-filters is lower.

Curve 620 of FIG. 6 shows a possible range of modulo unit output signal amplitudes. As shown, the amplitudes are mapped to a range of −8 and +8. The modulo units of FIG. 5 perform a similar type of amplitude mapping. The modulo mapping is dependent upon the magnitude of the amplitude of the input signal. The input amplitudes are all mapped down to the −8 to +8 amplitude range.

In another embodiment, the modulo shift controller (such as the controller 590 of FIG. 5) uses a fast version of the coupled feedback filter to estimate the modulo shift. This faster filter can be implemented by the controller using reduced precision feedback values (Y′₂ₙ₋₁, Y′₂ₙ₋₂, etc) and coefficients (A′, B′, C′, . . . ), which speeds up the arithmetic necessary to compute the estimate of the modulo shift values. Alternatively, look-up tables (possibly using smaller word lengths for both data and coefficients) can be used. For example, if the feedback FIR coefficients are [1.09, 0.55, −0.82], these values could be approximated by the binary hardware friendly representation [1, 0.5, −0.75], which requires only 3 bit representation of the coefficients. Similarly, the feedback symbol values (Y₂ₙ₋₁, Y₂ₙ₋₂, etc) can also be represented in reduced precision arithmetic to speed up the modulo shift estimate or reduce the hardware required. This can be combined with the prior values P₂ₙ to get an even better estimate of the modulo shift and thus require a reduced number of sub-filters.

Referring back to FIG. 3, it can be observed that the selection of the output of the MUX 390 can be a critical timing path in the selection of a sub-filter 352, 354, 356 as the output of the second feedback filter 350. The selection can be more efficiently made by reducing the precision of the modulo unit 312 of the first feedback filter 310. This can be accomplished by reducing the precision of the samples input to the modulo unit 312. For example, replicating the parallel filter 310 with multipliers and adders that include a reduced number of bits, generates an estimate for the input of the modulo 312 more quickly. The reduced precision (generally, less bits) of the samples reduces the complexity, and therefore, the required computation time of the modulo unit 312. For several feedback filters, in which each feedback filter includes a non-linear operator (modulo unit), at least one of the non-linear operators receive input estimates that are lower precision than other processing of the feedback filters.

Again referring back to FIG. 3, it can be observed that the sub-filters 352, 354, 356 have common filter coefficients (for example, A, ABC, A²+B). An efficient implementation includes these common coefficients being shared. More generally, for a plurality of sub-filters, the sub-filters share filter coefficients. Each of the sub-filters receives a corresponding modulo shift.

The feedback filters that include sub-filters are more complex than the feedback filters that don't include sub-filters. As a result, the feedback filters that include sub-filters typically will take longer to compute or process output samples. The computation time of the sub-filters can be reduced by implementing the computation of the sub-filters with look up tables (LUTs) rather than more time consuming multipliers and accumulators.

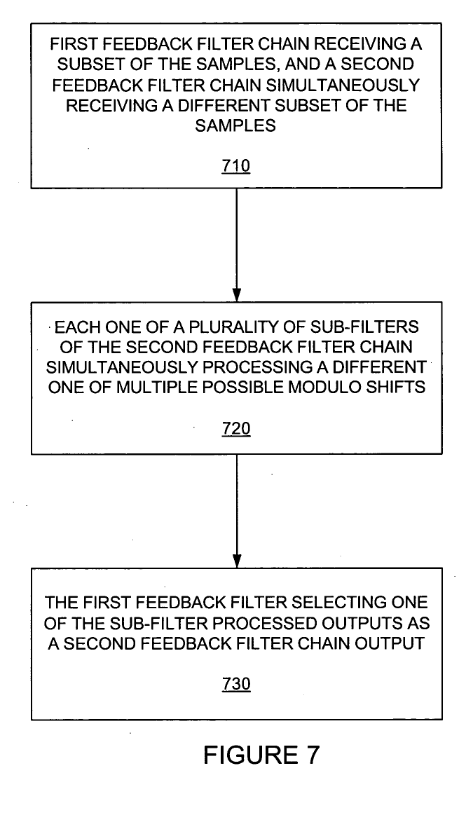

FIG. 7 is a flow chart showing steps included in a method of parallel feedback processing. A first step 710 includes a first feedback filter chain receiving a subset of the samples, and a second feedback filter chain simultaneously receiving a different subset of the samples. A second step 720 includes each sub-filter of the second feedback filter chain simultaneously processing a different one of multiple possible modulo shifts. A third step 730 includes the first feedback filter selecting one of the sub-filter processed outputs as a second feedback filter chain output.

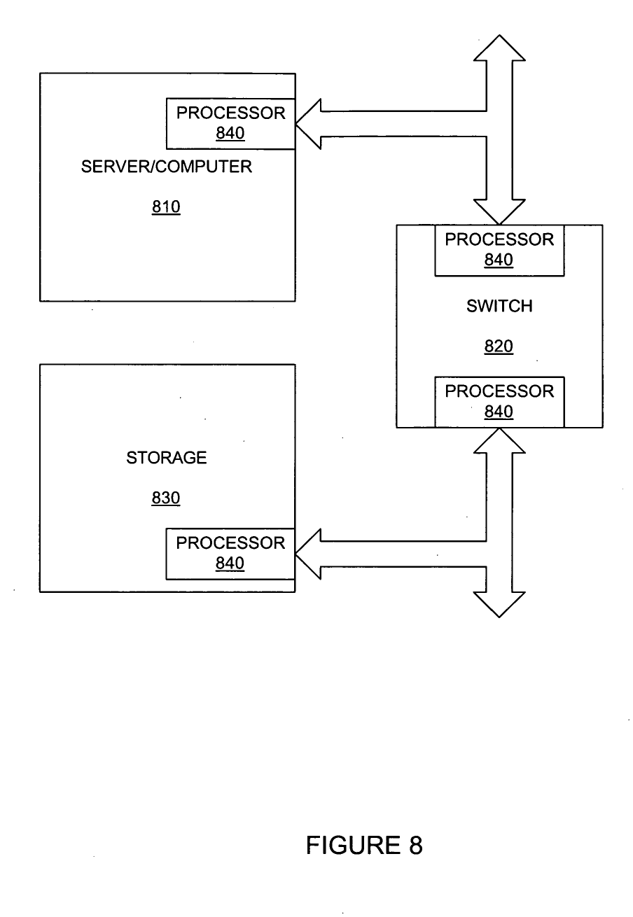

FIG. 8 is a block diagram of a server/computer 810, a switch 820 and storage 830 that can benefit from the use of a parallel feedback processor 840. The server/computer 810 can be connected to the switch 820 through an Ethernet twisted pair LAN connection. The switch 820 can additionally be connected to the storage 830 through an Ethernet twisted pair LAN connection. The parallel feedback processors 840 within the server/computer 810, the switch 820, and the storage 830 can provide minimization of ISI and FEXT interference of the Ethernet twisted pair LAN connections.

Although specific embodiments of the invention have been described and illustrated, the invention is not to be limited to the specific forms or arrangements of parts so described and illustrated. The invention is limited only by the appended claims.

1. A parallel feedback processor, comprising:
a plurality of parallel coupled feedback filters, each feedback filter comprising a non-linear operator;
at least one feedback filter comprising a plurality of sub-filters, each sub-filter computing one of possible non-linear operator filter outputs of the at least one feedback filter;
wherein one sub-filter output is selected as an output of the at least one feedback filter.

2. The parallel feedback processor of claim 1, wherein each of the feedback filters receives a subset of input samples of a transmitter signal stream.

3. The parallel feedback processor of claim 2, wherein each filter receives 1/N of the input samples, where N equals the number of feedback filters.

4. The parallel feedback processor of claim 1, wherein the non-linear operator is a modulo operator.

5. The parallel feedback processor of claim 1, wherein the non-linear operator is a constellation slicer.

6. The parallel feedback processor of claim 1, wherein the preprocessor comprises a Tomlinson-Harashima processor.

7. The parallel feedback processor of claim 1, wherein feedback of the processor comprises at least one FIR filter.

8. The parallel feedback processor of claim 1, wherein feedback of the processor comprises at least one IIR filter.

9. The parallel feedback processor of claim 1, wherein the sub-filter output is selected by an output of the non-linear operator of at least one other of the feedback filters.

10. The parallel feedback processor of claim 9, wherein the sub-filter output is selected by an output of the non-linear operator of a sub-filter of at least one other of the feedback filters.

11. The parallel feedback processor of claim 4, wherein a number of sub-filters is equal to a number of possible modulo shifts of the modulo operator.

12. The parallel feedback processor of claim 4, wherein a plurality of feedback filters comprises sub-filters, and a number of sub-filters of each feedback filter is equal to a product of a number of possible modulo shifts of a subset of the feedback filters.

13. The parallel feedback processor of claim 11, wherein the number of possible modulo shifts is determined by feedback coefficients of the feedback filters.

14. The parallel feedback processor of claim 13, wherein the number of possible modulo shifts is determined by summing absolute values of the feedback coefficients of the feedback filters.

15. The parallel feedback processor of claim 11, wherein the number of possible modulo shifts is determined by a range of amplitude values of input signals to the modulo operator.

16. The parallel feedback processor of claim 1, wherein a number of sub-filters is determined by selecting a desired signal distortion, and selecting the number of sub-filters required to ensure that the signal distortion is less than the desired signal distortion.

17. The parallel feedback processor of claim 1, wherein only sub-filters most likely to be selected are included within the parallel feedback processor.

18. The parallel feedback processor of claim 4, wherein a number of sub-filters is less than a number of possible modulo shifts of the modulo operator.

19. The parallel feedback processor of claim 18, wherein modulo shifts of the sub-filters are dynamically selected.

20. The parallel feedback processor of claim 19, wherein the dynamic selections are based upon partial values of previously occurring coefficients.

21. The parallel feedback processor of claim 19, wherein the dynamic selections are based upon lower resolution values of feedback coefficients.

22. The parallel feedback processor of claim 1, wherein outputs of the sub-filters are selected by a sub-filter MUX, an output of the sub-filter MUX generating the at least one feedback filter output.

23. The parallel feedback processor of claim 1, wherein a signal processor pre-processes a digital signal stream for transmission.

24. The parallel feedback processor of claim 1, wherein a signal processor post-processes a received digital signal stream.

25. The parallel feedback processor of claim 23, wherein a receiver reverses a transmit modulo operation.

26. The parallel feedback processor of claim 1, wherein at least one of the non-linear operators receive input estimates that are lower precision than other processing of the feedback filters.

27. The parallel feedback processor of claim 1, wherein a plurality of the sub-filters share filter coefficients.

28. The parallel feedback processor of claim 1, wherein select operations within the feedback filters are implemented with look up tables (LUT)s.

29. A method of parallel feedback processing, comprising:
receiving a digital stream of samples;
a first feedback filter processing a subset of the samples;
a second feedback filter simultaneously receiving and processing a different subset of the samples, the simultaneous processing comprising;
multiple sub-filters receiving the different subset of samples;
each sub-filter processing a different one of a number of possible non-linear operator ouputs; and
the first feedback filter selecting one of the sub-filter processed outputs as a second feedback filter chain output.

30. The method of parallel feedback processing of claim 29, wherein each sub-filter processing a different one of a number of possible non-linear operator ouputs comprises each sub-filter processing a different one of a number of possible modulo shifts.

31. The method of parallel feedback processing of claim 30, wherein a number of sub-filters is equal to the number of possible modulo shifts of a modulo operator of the first feedback filter.

32. The method of parallel feedback processing of claim 30, wherein the number of possible modulo shifts is determined by coefficients of the feedback filters.

33. The method of parallel feedback processing of claim 30, wherein the number of possible modulo shifts is determined by summing absolute values of the feedback coefficients of the feedback filters.

34. The method of parallel feedback processing of claim 30, wherein the number of possible modulo shifts is determined by a range of amplitude values of input signals to the modulo unit.

35. The method of parallel feedback processing of claim 29, wherein a number of sub-filters is determined by selecting a desired signal distortion, and selecting the number of sub-filters required to ensure that the signal distortion is less than the desired received signal distortion.

36. The method of parallel feedback processing of claim 29, wherein only sub-filters most likely to be selected are included within a parallel feedback processor.

37. The method of parallel feedback processing of claim 30, wherein a number of sub-filters is less than a number of possible modulo shifts of a modulo operator.

38. The method of parallel feedback processing of claim 30, wherein modulo shifts of the sub-filters are dynamically selected.

39. The method of parallel feedback processing of claim 29, wherein the non-linear operator is a slicer, and slicer output values of the sub-filters are dynamically selected.

40. The method of parallel feedback processing of claim 38, wherein the dynamic selections are based upon partial values of previously occurring coefficients.

41. The method of parallel feedback processing of claim 38, wherein the dynamic selections are based upon reduced resolution feedback values of coefficients.

42. A network line card, the network line card comprising a bi-directional transceiver, the bi-directional transceiver comprising a parallel feedback processor, the parallel feedback processor comprising:
a plurality of parallel coupled feedback filters, each feedback filter comprising a non-linear operator;
at least one of feedback filter comprising a plurality of sub-filters, each sub-filter computing one of possible non-linear operator filter outputs of the at least one feedback filter;
wherein one sub-filter output is selected as an output of the at least one feedback filter.

43. A server comprising a bi-directional transceiver, the bi-directional transceiver comprising a parallel feedback processor, the parallel feedback processor comprising:
a plurality of parallel coupled feedback filters, each feedback filter comprising a non-linear operator;
at least one of feedback filter comprising a plurality of sub-filters, each sub-filter computing one of possible non-linear operator filter outputs of the at least one feedback filter;
wherein one sub-filter output is selected as an output of the at least one feedback filter.

44. A storage unit comprising a bi-directional transceiver, the bi-directional transceiver comprising a parallel feedback processor, the parallel feedback processor comprising:
a plurality of parallel coupled feedback filters, each feedback filter comprising a non-linear operator;
at least one of feedback filter comprising a plurality of sub-filters, each sub-filter computing one of possible non-linear operator filter outputs of the at least one feedback filter;
wherein one sub-filter output is selected as an output of the at least one feedback filter.

45. A switch comprising a bi-directional transceiver, the bi-directional transceiver comprising a parallel feedback processor, the parallel feedback processor comprising:
a plurality of parallel coupled feedback filters, each feedback filter comprising a non-linear operator;
at least one of feedback filter comprising a plurality of sub-filters, each sub-filter computing one of possible non-linear operator filter outputs of the at least one feedback filter;
wherein one sub-filter output is selected as an output of the at least one feedback filter.
